(19) United States
(12) Patent Application Publication
(10) Pub. No.: US 2008/0195478 A1
(43) Pub. Date: Aug. 14, 2008

(54) Method and System For Prohibiting Combinations of Adverts

(76) Inventors: Kyoung-Ro Yoon, Seoul (KR); Sun-Young Han, Seoul (KR); Hee-Kyung Lee, Daejon (KR); Jung-Won Kang, Seoul (KR); Jae-Gon Kim, Daejon (KR)

Correspondence Address: LADAS & PARRY LLP, 224 SOUTH MICHIGAN AVENUE, SUITE 1600, CHICAGO, IL, 60604, US

(21) Appl. No.: 11/722,538

(22) PCT Filed: May 16, 2005
(86) PCT No.: PCT/KR05/01427

§ 371 Date: Jun. 22, 2007

(30) Foreign Application Priority Data
Dec. 24, 2004 (KR) 10-2004-0112396

(51) Int. Cl. G06Q 30/00

(52) U.S. Cl. 705/14

(57) ABSTRACT

Provided is a method and system for prohibiting a predetermined advertisement (ad) combination from being reproduced together within a predetermined period. The method includes: a) analyzing metadata including a prohibited combination period element for providing prohibited combination period information for prohibiting a combination of a first ad and a second ad and a condition element for providing condition information including characteristics information of the second ad; b) checking whether the second ad satisfying the condition is reproduced in the prohibited combination period; and c) when the second ad is not reproduced, reproducing the first ad and blocking the second ad from being reproduced during the prohibited combination period. When the second ad is reproduced, the first ad is not reproduced. The technology of the present invention can prohibits a predetermined combination of ads in an environment where ads can be substituted in a digital broadcasting receiving apparatus .

### TECHNICAL FIELD

The present invention relates to interstitial contents that prevent a predetermined combination of advertisements (ads); and more particularly, to a method and system that can prevent a predetermined combination of ads from being shown in a predetermined period so that predetermined ads cannot be reproduced together within a predetermined period.

### BACKGROUND ART

As broadcasting is digitalized, broadcasting environments are rapidly changed from conventional uni-directional broadcasting reception to multi-channel reception and even into such a complex form as accommodation of diverse reception terminals by connecting a broadcasting network with a communication network. An increasing number of broadcasting viewers want to get out of inactively receiving and watching broadcasting programs through limited channels and to participate in broadcasting services or demand to receive and watch desired programs at desired time.

The trend shows that the broadcasting environments are evolving into more complicated and personalized forms. Personalized broadcasting makes the viewers consume desired contents at desired time with diverse terminals based on their preferences in desired formats conveniently and efficiently in the diverse and new broadcasting environments.

The personalized broadcasting is to provide broadcasting contents suitably to a usage environment including user preference, terminal performance, network characteristics, and natural environment such as time, place and the feeling of a user.

The standards for the personalized broadcasting are divided into Phase 1, which is a TV Anytime 1 (TVA-1), and Phase 2, which is a TVA-2, based on an assumed system environment and a major function to be provided. The TVA-1 provides such application services as search, selection, acquisition and consumption of audio/video (AV) contents with a personal digital recoder (PDR) in an environment where a main broadcasting program is transmitted through a uni-directional broadcasting channel and additional metadata are available through a bi-directional network.

The TVA-2 extends the consumption environment of the TVA-1 which assumes a unit-directional broadcasting channel and a bi-directional network. It supports contents sharing between diverse terminals in a home network environment and provides a targeting service for providing contents that fits to diverse user environments. The TVA-2 also accommodates not only the AV of the TVA-1 but also diverse forms of contents.

Predetermined broadcasting advertisements (ads) such as TV commercials are reproduced repeatedly according to a contract with a broadcasting company while a predetermined program is broadcasted. The broadcasted ads are shown in other broadcasting channels, too, repeatedly. In an environment with sufficient storage capacity, it is possible to store a predetermined number of ads in a personal storage and reproduce the ads from the personal storage upon a signal transmitted through a broadcasting program. Of course, it is possible to reproduce the ads after receiving them from a communication network. When the environment is built up, it is possible to provide user-specified ads.

To provide the user-specified ads, the following information is in need. First, the location for an ad to be inserted into the broadcasting program should be specified. If necessary, the ad time, which means the length of the ad to be inserted into the specified location, may be specified.

The designated ad insertion location should include the descriptions on the ads available for an insertion location or it should be linked with the descriptions on the stored ads. The description on an ad says in what conditions each of the ads can be inserted into a predetermined ad insertion location. In short, the description specifies the conditions to be satisfied when an ad is to be shown.

FIG. 1 shows an example of usage condition of an ad. The example says that a given ad is available for broadcasting viewers who is older than 35, living in Seoul, Korea, and not working in the education field from Oct. 1, 2004, through Oct. 20, 2004.

FIG. 2 presents an example of exclusion condition of an ad. The example says that the given ad is not available for those who are older than 35 and not working in the education field.

However, when the showing of ads of a predetermined combination needs to be avoided due to the characteristics of the ads, such as a combination of an automobile ad of a company followed by an automobile ad of its competitor, there has been no method that can properly describe the prohibition.

### DISCLOSURE

### Technical Problem

It is, therefore, an object of the present invention to provide a method and system that can efficiently prevent a predetermined combination of ads in a personalized digital broadcasting environment.

### Technical Solution

In accordance with one aspect of the present invention, there is provided a method for prohibiting an advertisement (ad) combination, the method including the steps of: a) analyzing metadata including a prohibited combination period element for providing prohibited combination period information when a combination of a first ad and a second ad is prohibited and a condition element for providing condition information including characteristics information of the second ad to thereby obtain the prohibited combination period information and the condition information; b) checking whether the second ad satisfying the condition is reproduced in the prohibited combination period; and c) when the second ad is not reproduced, reproducing the first ad and blocking the second ad from being reproduced during the prohibited combination period. When the second ad is reproduced, blocking the first ad from being reproduced.

The prohibited combination period may include a negative time and a positive time based on the reproduction time of the first ad. Herein, when the second ad is not reproduced in a duration from the beginning of the negative time to the reproduction time of the first ad, reproduction of the second ad is blocked in the duration from the reproduction time of the first ad to the end of the positive time.

The characteristics information may include at least any one selected from the group consisting of a product name, a product category, a brand name, a manufacturer, and a right holder of the ad.

The condition element may include a “PredicateBag” element which is formed of a “BinaryPredicate” element and a “UnaryPredicate” element. A field which the “BinaryPredicate” and “UnaryPredicate” elements refer to includes at least any one selected from the group consisting of a product name, a product category, a brand name, a manufacturer, and a right holder of the ad.

In accordance with another aspect of the present invention, there is provided a method for prohibiting an ad combination, the method including the steps of: a) analyzing metadata including a prohibited combination period element for providing prohibited content combination period information when a combination of a first ad and a second ad is prohibited and a condition element for providing condition information including characteristics information of the second ad to thereby obtain the prohibited content combination period information and the condition information; b) checking whether the second ad satisfying the condition is reproduced in the prohibited content combination period; and c) when the second ad is not reproduced, reproducing the first ad and blocking the second ad from being reproduced during the prohibited content combination period. When the second ad is reproduced, blocking the first ad from being reproduced. The content is any one among an add insertion location, which is a pod, a segment, and a program.

The prohibited content combination period element may include an attribute “From” and an attribute “To.” Negative values and positive values of the attributes indicate contents before the reproduction time of the first ad by the absolute value and contents after the reproduction time of the first ad by the absolute value, respectively. When the attribute “From” has a negative value and the attribute “To” has a positive value and the second ad is not reproduced in a duration from a content at the negative value to the reproduction time of the first ad, blocking the second ad from being reproduced in a duration from the reproduction time of the first ad to the end of a content at the positive value.

In accordance with another aspect of the present invention, there is provided a system for prohibiting an ad combination, which includes: a metadata analyzing unit for analyzing metadata including a prohibited combination period element for providing prohibited combination period information when a combination of a first ad and a second ad is prohibited and a condition element for providing condition information including characteristics information of the second ad to thereby obtain the prohibited combination period information and the condition information; an ad reproduction checking unit for checking whether the second ad satisfying the condition is reproduced in the prohibited combination period; and an ad reproduction blocking unit for, when the second ad is not reproduced, reproducing the first ad and blocking the second ad from being reproduced during the prohibited combination period.

In accordance with another aspect of the present invention, there is provided a system for prohibiting an ad combination, which includes: a metadata analyzing unit for analyzing metadata including a prohibited content combination period element for providing prohibited content combination period information when a combination of a first ad and a second ad is prohibited and a condition element for providing condition information including characteristics information of the second ad to thereby obtain the prohibited content combination period information and the condition information; an ad reproduction checking unit for checking whether the second ad satisfying the condition is reproduced in the prohibited content combination period; and an ad reproduction blocking unit for, when the second ad is not reproduced, reproducing the first ad and blocking the second ad from being reproduced during the prohibited content combination period.

### Advantageous Effects

The technology of the present invention prevents a predetermined combination of advertisements (ads) in an environment where ads can be substituted in a digital broadcasting reception apparatus.

### DESCRIPTION OF DRAWINGS

The above and other objects and features of the present invention will become apparent from the following description of the preferred embodiments given in conjunction with the accompanying drawings, in which:

FIG. 1 shows an example of usage condition of an advertisement (ad);

FIG. 2 describes an example of exclusion condition of an advertisement;

FIG. 3 presents an Extensible Markup Language (XML) schema describing to exclude a predetermined ad in accordance with an embodiment of the present invention;

FIG. 4 shows an XML schema describing an ad description structure in accordance with an embodiment of the present invention;

FIG. 5 presents an XML schema describing an ad description structure extended based on contents based description type;

FIG. 6 is an XML schema excluding an ad combination from the XML schema of FIG. 3 in accordance with a first embodiment of the present invention;

FIG. 7 is an XML schema excluding an ad combination from the XML schema of FIG. 3 in accordance with a second embodiment of the present invention;

FIG. 8 is a flowchart describing an ad combination prohibiting process in accordance with a first embodiment of the present invention; and

FIG. 9 is a flowchart describing an ad combination prohibiting process in accordance with a second embodiment of the present invention.

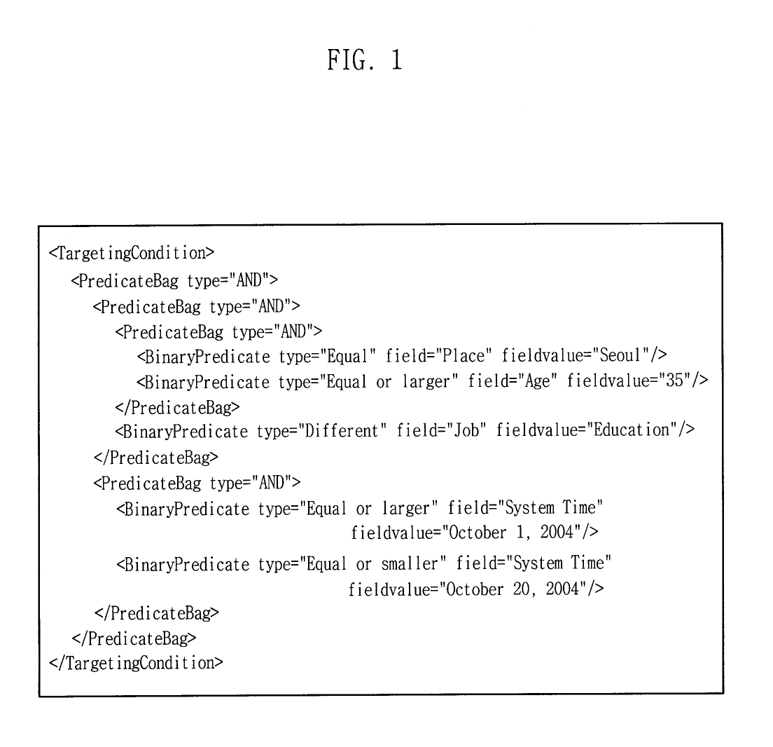

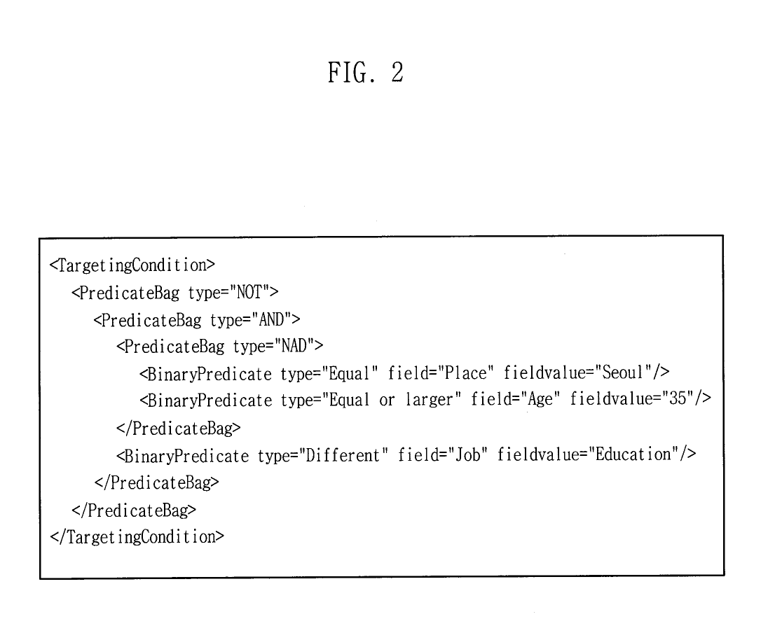

### BEST MODE FOR THE INVENTION

Other objects and aspects of the invention will become apparent from the following description of the embodiments with reference to the accompanying drawings, which is set forth hereinafter. When it is considered that detailed description on prior arts may blur the points of the present invention, the description will not be provided herein. Preferred embodiments of the present invention will be described with reference to the accompanying drawings, hereinafter.

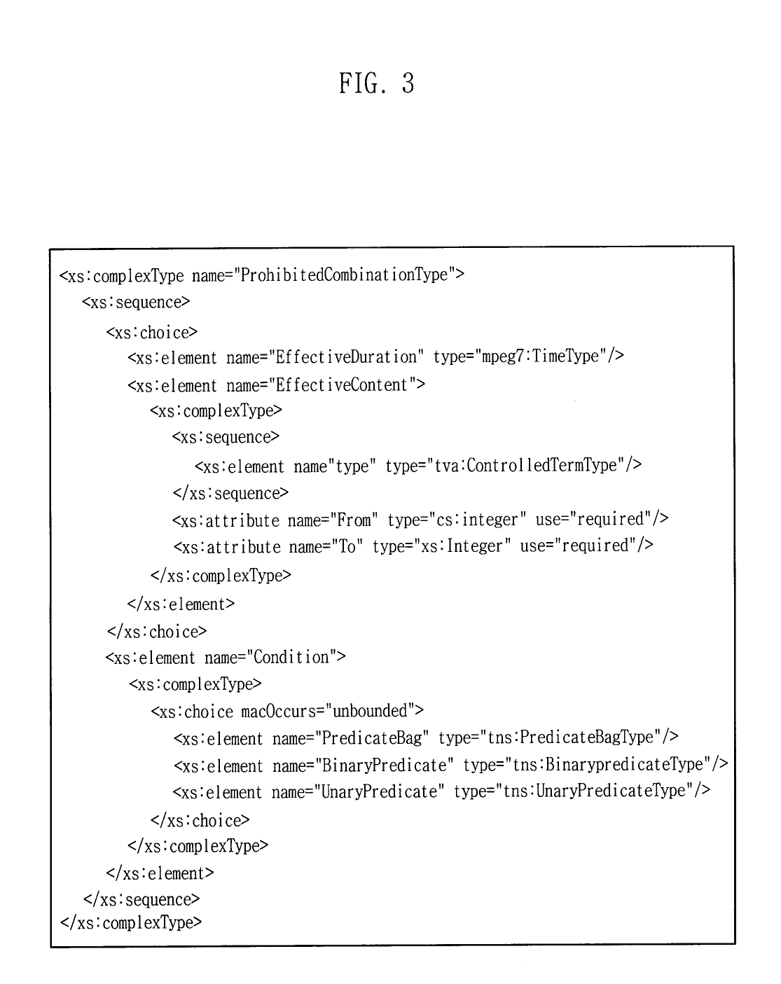

FIG. 3 presents an Extensible Markup Language (XML) schema describing to exclude a predetermined ad in accordance with an embodiment of the present invention. In a “ProhibitedCombinationType,” a prohibited combination period element “EffectiveDuration” specifies a time period in which an ad satisfying conditions described in a “Condition” element cannot be reproduced.

The “EffectiveDuration” defines the time when the ad specified with an element “ProhibitedCombination” is reproduced from a negative time to a positive time. The negative time defines time prior to a moment when the ad with the “ProhibitedCombination” is selected and reproduced, whereas the positive time defines time posterior to the moment.

The “EffectiveDuration” can be represented as a starting moment and a duration based on a moment when insertion of an ad is considered according to a time period description method.

To be specific, when an ad with the “ProhibitedCombination,” which will be referred to as an ad A, hereinafter, it is checked whether there is an ad which is satisfying the conditions described in the element “Condition” of the “ProhibitedCombination” given to the ad A and selected and reproduced during a predetermined time specified in the “EffectiveDuration.”

If the ad B satisfying the conditions described in the element “Condition” is already selected and reproduced, the ad A, which is an exclusionary ad of the ad B, cannot be selected during the predetermined time specified in the “EffectiveDuration.”

On the contrary, if there is not the ad B satisfying the condition described in the element “Condition” in the selected ads, the ad A can be selected. Once the ad A is selected for reproduction, the ad B satisfying the conditions as the exclusionary ad of the ad A cannot be selected for the predetermined time specified in the “EffectiveDuration. ”

When the ad A is to be selected in the “EffectiveDuration,” it should be checked whether the ad B satisfying the condition specified in the “Condition” of the “ProhibitedCombination” is selected or not during a period from time prior to the selection time by as much as the time defined in the negative time to the selection time.

Also, when the ad A is selected in the “EffectiveDuration,” it should be continuously checked whether the ad B is not selected until the end of the time defined in the positive time from the selection time.

A prohibited content combination period element “EffectiveContent” is a content period in which an ad satisfying the condition described in the “Condition” element of the “ProhibitedCombination” cannot be reproduced. When a viewer watches a segment or a program defined in the “EffectiveContent,” it means that an ad satisfying the condition described in the “Condition” cannot be reproduced.

Attributes “From” and “To” signify relative count of contents. A value ‘0’ means a current content and negative numbers signify previous contents while positive numbers stand for next contents. A content unit can be an ad insertion location, i.e., pod, or a segment or a program by specifying an attribute “type.”

When an ad satisfying the condition described in the “Condition” for the current program only is supposed not to be reproduced, the attribute values of the “From” and “To” should be all ‘0’ and the attribute “type” should be a program.

For example, when the attribute “From” is −2 and the attribute “To” is 3, an ad satisfying the condition described in the “Condition” of the “ProhibitedCombination” cannot be selected within a time period from the starting time of the second previous contents from the current content, which is a segment, an ad insertion location or a program, to the end time of the third next content from the current content.

In other words, the “EffectiveDuration” and the “EffectiveContent” are the same prohibition conditions. The difference between them is that “EffectiveContent” makes the ad B not selected based on the number of ad insertion locations, segments and programs which is defined in the “type” whereas the “EffectiveDuration” makes the ad B not selected based on the time.

The element “Condition” which includes predicate describes a condition that an ad to be prohibited should satisfy.

The element “Condition” can be represented by using an element “PredicateBag.” The “PredicateBag” includes “BinaryPredicate,” “UnaryPredicate” and low-order “PredicateBag.”

The basic structures of the “BinaryPredicate,” “UnaryPredicate” and low-order “PredicateBag” are defined in the TVA-1 S006 Part 1. The “PredicateBag” follows a logical description scheme. In other words, in the uppermost level, the “PredicateBag” uses the conditions defined in the low-order elements as they are, or it can use the low-order elements by defining the “type” value as “NOT” and thus denying the conditions defined in the low-order elements.

The “PredicateBag” can include a “PredicateBag” as its low-order element reflexively and it can specify complicated conditions in a Boolean algebraic method. In short, the “PredicateBag” can define the conditions in the Boolean algebraic method by having “AND” or “OR” in the “type.”

The “PredicateBag” includes either “BinaryPredicate” or “UnaryPredicate.” The “BinaryPredicate” checks whether the conditions defined in the “type,” i.e., comparative operation, are satisfied, when a “field” value is compared with a “fieldvalue.”

The “UnaryPredicate” is used to check whether there is a “field.” The “UnaryPredicate” is used when there is no “fieldvalue” to be compared with.

A field referred to by the “BinaryPredicate” or the “UnaryPredicate” should describe the characteristics of the ad. In the present embodiment of the invention, the field includes a product name, a product category, a brand name, a manufacturer, and a right hold for the content.

When the value of the lowermost “BinaryPredicate” or the “UnaryPredicate” is determined to be “True” or “False,” the value of the uppermost “PredicateBag” can be calculated through the Boolean Algebraic operation of “AND,” “OR,” and “NOT” according to the “type” of the “PredicateBag” including them.

When the uppermost “PredicateBag” value is “True,” it means that the ad satisfies the condition described in the “Condition” element of the ad. When uppermost “PredicateBag” value is “False,” it means that the ad does not satisfy the condition described in the “Condition” element of the ad.

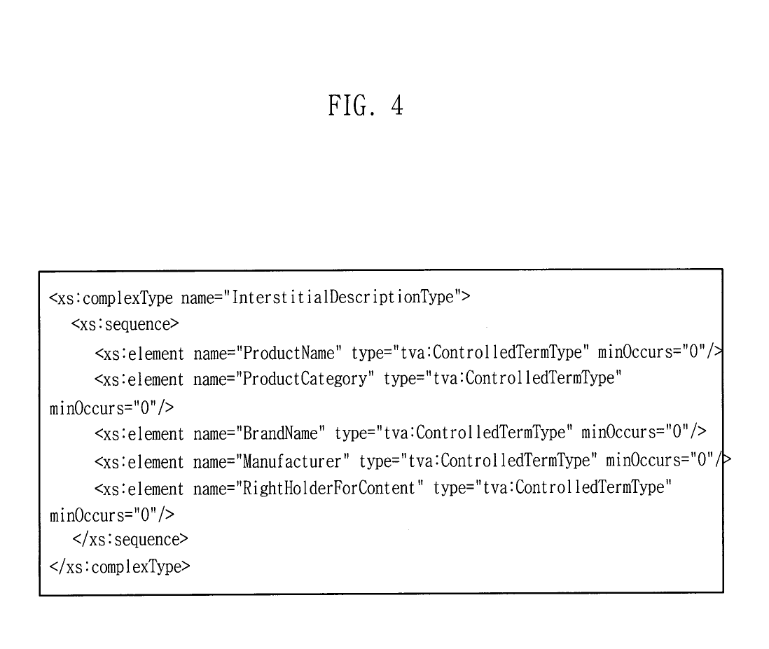

FIG. 4 shows an XML schema describing an ad description structure in accordance with an embodiment of the present invention. The XML schema describes the ad by using such elements as the name of a product, a product category, a brand name, a manufacturer, a right holder of the ad.

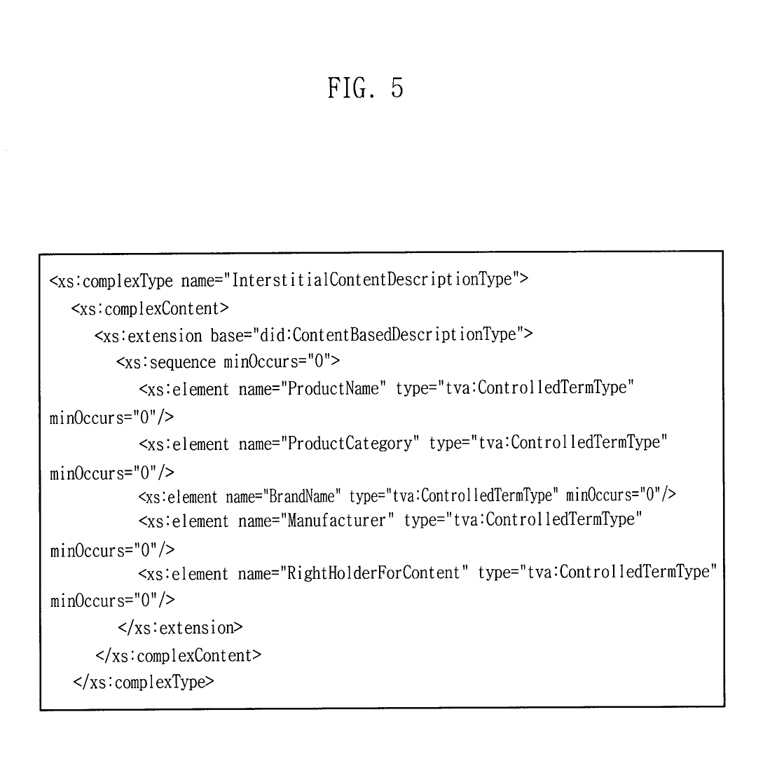

FIG. 5 presents an XML schema describing an ad description structure extended based on contents based description type (“ContentsBasedDescriptionType”). An ad can be formed into a content unit of the same level as an AV content by extending the ad description structure based on the content based description type. Thus, it is possible to identify ad, resolute the location of the ad and acquire the ad by using a Content Reference Identifier (CRID).

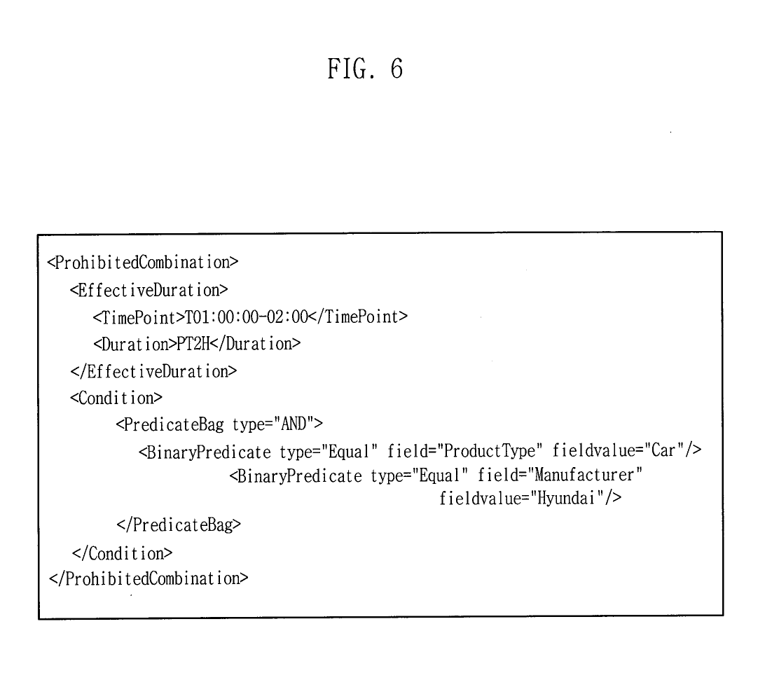

FIG. 6 is an XML schema excluding an ad combination from the XML schema of FIG. 3 by using the “EffectiveDuration” in accordance with a first embodiment of the present invention.

To take an example, it is assumed that a Daewoo Motor ad is to be selected and reproduced. To exclude a predetermined ad combination, the “ProhibitedCombination” connected to the Daewoo Motor ad is checked.

In the drawing, the “EffectiveDuration” indicates that the effective duration is from a time point one hour after a reference time point obtained by subtracting two hours from the current time point to a time point two hours after the reference time. In short, the ad is effective from one hour before the current time point to one hour after the current time point.

Subsequently, it is checked whether an ad satisfying a condition defined in the “Condition” element, that is, an ad of which the manufacturer is a Hyundai Motor and the product type is an automobile, i.e., a Hyundai Motor ad, is shown between one hour before and after the current time point. The result may be one of the following two cases.

A first case is that Hyundai Motor ad is not shown. In this case, the Daewoo Motor ad is selected and inserted, i.e., reproduced, at the current time point. Once the Daewoo Motor ad is reproduced, the “ProhibitedCombination” is effective from the current time point, i.e., the moment when the Daewoo Motor ad is inserted, for an hour.

Therefore, whenever another ad is inserted in a duration from the current reference time to a time point one hour after the reference time, the condition “ProhibitedCombination” is checked. When a Hyundai Motor ad is attempted to be inserted in 30 minutes from the reference time, the attempt is rejected because the “ProhibitedCombination” of the Daewoo Motor ad which is already inserted is still effective.

The second case is that the Hyundai Motor ad is already shown. If it is shown already and less than an hour has passed since it is shown, the insertion of the Daewoo Motor ad is rejected according to the condition of the negative time.

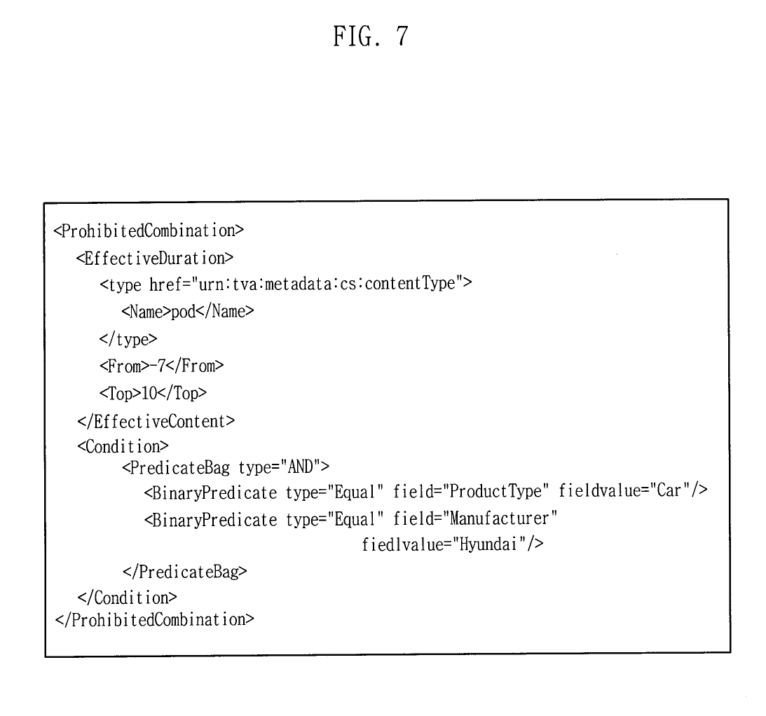

FIG. 7 is an XML schema excluding a predetermined ad combination from the XML schema of FIG. 3 based on the “EffectiveContent” in accordance with a second embodiment of the present invention.

Herein, it is assumed that the Daewoo Motor ad is to be selected and reproduced at the current time point. First, the “ProhibitedCombination” connected to the Daewoo Motor ad is checked.

Since the content type is given as “pod,” the “EffectiveContent” is from the insertion point of a 7^{th} ad from the current time point, which is the reference time point, to the insertion point of a 10^{th} ad from the reference point.

It is checked whether an ad satisfying the condition specified in the “Condition” element, that is, an ad of which the manufacturer is Hyundai Motor and the product type is an automobile, i.e., a Hyundai Motor ad, is shown in the duration from the insertion point of the previous 7^{th} ad to the current time point. The result may be one of the following two cases.

A first case is that Hyundai Motor ad is not shown. In this case, the Daewoo Motor ad is selected and inserted, i.e., reproduced, at the current time point. Once the Daewoo Motor ad is reproduced, the “ProhibitedCombination” is effective from the current time point, i.e., the moment when the Daewoo Motor ad is inserted, to the insertion time point of a 10^{th} ad.

Therefore, the condition is checked whenever an ad is inserted at 10 ad insertion time points from the reference time. When the Hyundai Motor ad is attempted to be inserted at the fourth ad insertion time point from the reference time, the attempt is rejected because the “ProhibitedCombination” of the Daewoo Motor ad, which is already inserted, is still effective.

The second case is that the Hyundai Motor ad is already shown. If it is shown already and less than 7 ad insertion points are not passed by yet after the Hyundai Motor ad is shown, the insertion of the Daewoo Motor ad is rejected.

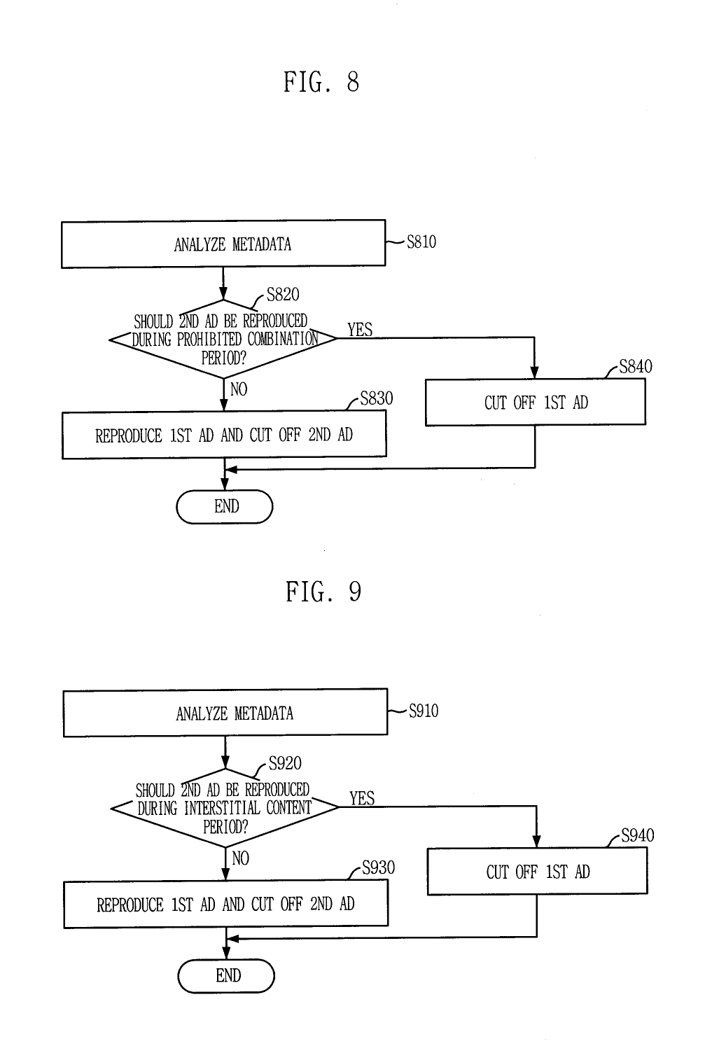

FIG. 8 is a flowchart describing an ad combination prohibiting process in accordance with a first embodiment of the present invention. In step S810, “ProhibitedCombination” metadata are analyzed to obtain prohibited combination period information for preventing a combination of a first ad and a second ad and condition information including characteristics information of the second ad.

In step S820, it is checked whether the second ad satisfying the condition is reproduced or not in the prohibited combination period. To be specific, it is checked whether the second ad is reproduced or not in a duration from the beginning of the negative time of the prohibited combination period to the reproduction period of the first ad.

If the second ad is not reproduced, in step S830, the first ad is reproduced and the reproduction of the second ad is blocked during the prohibited combination period. To be specific, when the second ad is not reproduced in a duration from the beginning of the negative time of the prohibited combination period to the reproduction time of the first ad, the first ad is reproduced and the reproduction of the second ad is blocked in a duration from the reproduction time of the first ad to the end of the positive time of the prohibited combination period.

When the second ad is reproduced in the duration from the beginning of the negative time of the prohibited combination period to the reproduction time of the first ad, in step S840, the reproduction of the first ad is blocked.

FIG. 9 is a flowchart describing an ad combination prohibiting process in accordance with a second embodiment of the present invention.

In step S910, “ProhibitedCombination” metadata are analyzed to obtain prohibited content combination period information for preventing a combination of a first ad and a second ad and condition information including characteristics information of the second ad in an ad combination prohibiting system.

Subsequently, in step S920, it is checked whether the second ad satisfying the condition is reproduced or not in the prohibited content combination period. To be specific, it is checked whether the second ad is reproduced in a duration from a proceeding content at a negative value of an attribute “From” of the prohibited content combination element to the reproduction time of the first ad.

When the second ad is not reproduced, in step S930, the first ad is reproduced and the reproduction of the second ad is blocked in the prohibited content combination. To be specific, when the second ad is not reproduced in the duration from the proceeding content at the negative value of the attribute “From” of the prohibited content combination element to the reproduction time of the first ad, the first ad is reproduced and the reproduction of the second ad is blocked in a duration from the reproduction time of the first ad to a content at a positive value of an attribute “To” of the prohibited content combination period element.

When the second ad is reproduced in the duration from the content at the negative value of the attribute “From” of the prohibited content combination period to the reproduction time of the first ad, in step S940, the reproduction of the first ad is blocked.

The method of the present invention can be realized as a program and stored in a computer-readable recording medium.

While the present invention has been described with respect to certain preferred embodiments, it will be apparent to those skilled in the art that various changes and modifications may be made without departing from the scope of the invention as defined in the following claims.

### INDUSTRIAL APPLICABILITY

The technology of the present invention can be applied to a personalized digital broadcasting of the TVA.

1-17. (canceled)

18. A method for providing an advertisement, comprising the steps of:
generating a metadata comprising condition information and prohibited combination information, wherein the condition information includes characteristic condition of the advertisement and the prohibited combination information includes prohibited condition for prohibiting the advertisement being replaced; and
transmitting the metadata to a user terminal.

19. The method as recited in claim 18, wherein the prohibited combination information comprises period information.

20. The method as recited in claim 18, wherein the prohibited combination information comprises information of count of contents.

21. The method as recited in claim 18, wherein the condition information comprises at least any one selected from a group including of unary condition information, binary condition information and lower-order condition information.

22. The method as recited in claim 18, wherein the condition information comprises Boolean algebra information.

23. The method as recited in claim 22, wherein the condition information comprises reverse information for reversing a result of the Boolean algebra.

24. The method as recited in claim 18, wherein the characteristic condition comprises an identifier for identifying the advertisement and at least any one selected from a group including of a product name, a product category, a brand name, a manufacturer, and a right holder of the advertisement

25. An apparatus for providing an advertisement, comprising:
a metadata generating unit for generating a metadata comprising condition information and prohibited combination information, wherein the condition information includes characteristic condition of the advertisement and the prohibited combination information includes prohibited condition for prohibiting the advertisement being replaced; and
a transmitting unit for transmitting the metadata to a user terminal.

26. The apparatus as recited in claim 25, wherein the prohibited combination information comprises period information.

27. The apparatus as recited in claim 25, wherein the prohibited combination information comprises information of count of contents.

28. The apparatus as recited in claim 25, wherein the condition information comprises at least any one selected from a group including of unary condition information, binary condition information or lower-order condition information.

29. The apparatus as recited in claim 25, wherein the condition information comprises Boolean algebra information.

30. The apparatus as recited in claim 29, wherein the condition information comprises reverse information for reversing a result of the Boolean algebra.

31. The apparatus as recited in claim 25, wherein the characteristic condition comprises an identifier for identifying the advertisement and at least any one selected from a group including of a product name, a product category, a brand name, a manufacturer, and a right holder of the advertisement.

32. A method for consuming an advertisement, comprising the steps of:
receiving a metadata comprising condition information and prohibited combination information, wherein the condition information includes characteristic condition of the advertisement and the prohibited combination information includes prohibited condition for prohibiting the advertisement being replaced; and
prohibiting the advertisement being satisfied with condition of the condition information and the prohibited combination information based on the metadata from being reproduced.

33. The method as recited in claim 32, wherein the prohibited combination information comprises period information.

34. The method as recited in claim 32, wherein the prohibited combination information comprises information of count of contents.

35. The method as recited in claim 32, wherein the condition information comprises at least any one selected from a group including of unary condition information, binary condition information and lower-order condition information.

36. The method as recited in claim 32, wherein the condition information comprises Boolean algebra information.

37. The method as recited in claim 36, wherein the condition information comprises reverse information for reversing a result of the Boolean algebra.

38. The method as recited in claim 32, wherein the characteristic condition comprises an identifier for identifying the advertisement and at least any one selected from a group including of a product name, a product category, a brand name, a manufacturer, and a right holder of the advertisement.

39. A user terminal for consuming an advertisement, comprising:
a receiving unit for receiving a metadata comprising condition information and prohibited combination information, wherein the condition information includes characteristic condition of the advertisement and the prohibited combination information includes prohibited condition for prohibiting the advertisement being replaced; and
a controlling unit for prohibiting the advertisement being satisfied with condition of the condition information and the prohibited combination information based on the metadata from being reproduced.

40. The user terminal as recited in claim 39, wherein the prohibited combination information comprises period information.

41. The user terminal as recited in claim 39, wherein the prohibited combination information comprises information of count of contents.

42. The user terminal as recited in claim 39, wherein the condition information comprises at least any one selected from a group including of unary condition information, binary condition information and lower-order condition information.

43. The user terminal as recited in claim 39, wherein the condition information comprises Boolean algebra information.

44. The user terminal as recited in claim 43, wherein the condition information comprises reverse information for reversing a result of the Boolean algebra.

45. The user terminal as recited in claim 39, wherein the characteristic condition comprises an identifier for identifying the advertisement and at least any one selected from a group including of a product name, a product category, a brand name, a manufacturer, and a right holder of the advertisement.
